(19) United States
(12) Patent Application Publication
(10) Pub. No.: US 2007/0101419 A1
(43) Pub. Date: May 3, 2007

(54) Apparatus, system, and method for providing electronically accessible personal information

(76) Inventor: Colin Scott Dawson, Tucson, AZ (US)

Correspondence Address: KUNZLER & ASSOCIATES, 8 EAST BROADWAY, SUITE 600, SALT LAKE CITY, UT, 84111, US

(21) Appl. No.: 11/263,197

(22) Filed: Oct. 31, 2005

(51) Int. Cl. H04L 9/32

(52) U.S. Cl. 726/9

(57) ABSTRACT

An apparatus, system, and method are disclosed for electronically accessible personal information. The apparatus, system and method facilitate individuals in electronically accessing personal information and using it to fill out electronic dialogs. Individuals can insert a personal information key into any computing device and auto-fill out application dialogs or select the appropriate information to fill out these dialogs. The personal information key may include all the personal information necessary to fill out a variety of application dialogs, such as web pages and forms, to conduct a variety of professional and personal transactions.

### BACKGROUND OF THE INVENTION

1. Field of the Invention

This invention relates generally to means and methods for providing personal information and more particularly relates to apparatus, systems, and methods for providing electronically accessible personal information

2. Description of the Related Art

In order to complete both personal and professional tasks, individuals are often asked to fill out a variety of forms, many of which require the same information. For example, conducting such transactions typically requires individuals to enter at least name, address and telephone information. In addition, individuals are commonly asked for references, emergency, and next-of-kin contacts. Individuals are also routinely asked for financial account information and are also often asked for insurance and medical information such as history and blood type.

FIG. 1 is a block diagram of a prior art system 100 for providing personal information. As depicted, the system 100 includes one or more personal information devices 110, a pen 115, a form 120, and a computing device 130. The personal information device 110 may be an electronic device capable of storing personal information such as electronic organizer, PDA, or mobile telephone with the capability to store such information. The personal information device 110 may also be a non-electronic device such as a planner, an address book, or a memo pad.

Commonly, individuals are asked to enter their personal information on the paper form 120 with a pen 115. Subsequently, the paper form 120 may be scanned or typed into a computing device 130 by office personnel. The computing device 130 can be any computing device capable of receiving personal information such as a personal computer, a networked computer, or an input terminal.

While carrying a personal information device 115 provides convenience to the user, the loss of the information stored thereon could result in the loss of vital, private information. Such a loss could lead to identity fraud or other types of theft. In addition, the information provided by the personal information device 115 is not readily transferable to the computing device 130. Individuals must look up the information and then manually enter it into the paper form 120. The process of manually entering the information into the paper form 120 is typically tedious and often introduces errors into the personal information.

Another disadvantage of the current art, is that subsequent to completion of the paper forms 120, the information on the forms must be re-entered into the computing device 130 resulting in additional errors such as typing mistakes, selecting the wrong information for entry, and misreading the information. Time is also wasted when the same information must be entered into multiple dialogs or forms within the computing device 130.

One proposed approach to addressing the problems associated with electronically-accessible, portable personal information is to implant a Radio Frequency Identification (RFID) chip containing identification data under the skin. A prominent example of this approach is the VeriChip™, which has received FDA approval as an implantable means of identification. While this approach assures that the information carried on the chip will be remain with the individual and not subject to loss or theft, there are a number of limitations associated with this approach.

Privacy concerns led to the VeriChip being used only to carry personal identification information. Since it is possible to access the data on an RFID chip without the permission or knowledge of the bearer, such chips are less secure as a means for carrying confidential information, such as medical records, as commonly assumed. Additionally, the hardware required for reading the data on an RFID is not readily available in many situations where personal data is required to be entered. Likewise, the means for modifying the data on an RFID is not readily accessible, making it inconvenient for the user to add to or modify the data carried on the chip.

From the foregoing discussion, it should be apparent that a need exists for an apparatus, system and method for providing electronically accessible personal information. Beneficially, such as apparatus, system and method would enable individuals to securely carry their personal information with them and quickly enter it into various application dialogs, such as electronic forms and web pages, with a minimum of manual input.

### SUMMARY OF THE INVENTION

The present invention has been developed in response to the present state of the art, and in particular, in response to the problems and needs in the art that have not yet been fully solved by currently available methods of providing individuals with electronically accessible personal information. Accordingly, the present invention has been developed to provide an apparatus, system, and method for providing electronically accessible personal information that overcomes many or all of the above-discussed shortcomings in the art.

The apparatus to provide electronically accessible personal information is provided with a plurality of modules that collectively provide a user's private, personal information in a secure manner. These modules in the described embodiments include a read/write module, a data storage module, a form-filling module, an authentication module, and an encryption/decryption module.

The apparatus, in one embodiment, is configured to access a personal information key that includes personal and private information about the owner and/or user of the key. The apparatus may be configured with applications having dialogs, such as forms, that the user must fill out in order to pursue a personal or business transaction. In one embodiment, the apparatus includes a key access module. The user may insert the personal information key into this key access module. Subsequently, the key access module may access the personal information on the key to automatically and/or interactively fill out the application dialogs on behalf of the user.

The apparatus is further configured, in one embodiment, to authenticate the owner of the key and assist the owner in creating and modifying the personal information stored on the key. In addition, the key access module may also include an encryption/decryption module. Once the owner is authenticated, the encryption/decryption module may encrypt information written to the personal information key and decrypt the information to be read from the personal information key.

In a further embodiment, the apparatus may be configured to include a data storage module that may store the owner's personal information such as addresses, phone numbers, insurance accounts such as medical and auto, and financial and medical information and histories in a particular format or storage structure. In addition, the personal information key may also include an authentication module containing information sufficient to verify the user.

In some embodiments, the authentication module includes a biometric sensor configured to provide biometric information. In certain embodiments, the authentication module includes a portion of the non-volatile memory containing authentication information, such as user names and passwords.

A system of the present invention is also presented to provide electronically accessible personal information. The system may be embodied with a personal information key and a computing device configured with a key access module

A method of the present invention is also presented for providing electronically accessible personal information. The method in the disclosed embodiments substantially includes the operations necessary to carry out the functions presented above with respect to the operation of the described apparatus and system. In one embodiment, the method includes operations to authenticate a user of the personal environment key, access the personal information stored on the personal identification key and filling out one or more dialogs or forms presented on a computing device.

The present invention offers distinct advantages over the prior art. One advantage is the ability to automatically enter personal information without risk of typographic errors. Another advantage of the present invention is the ability to reduce the redundant entering of the same information into numerous forms.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram depicting one embodiment of a prior art system for accessing personal information;

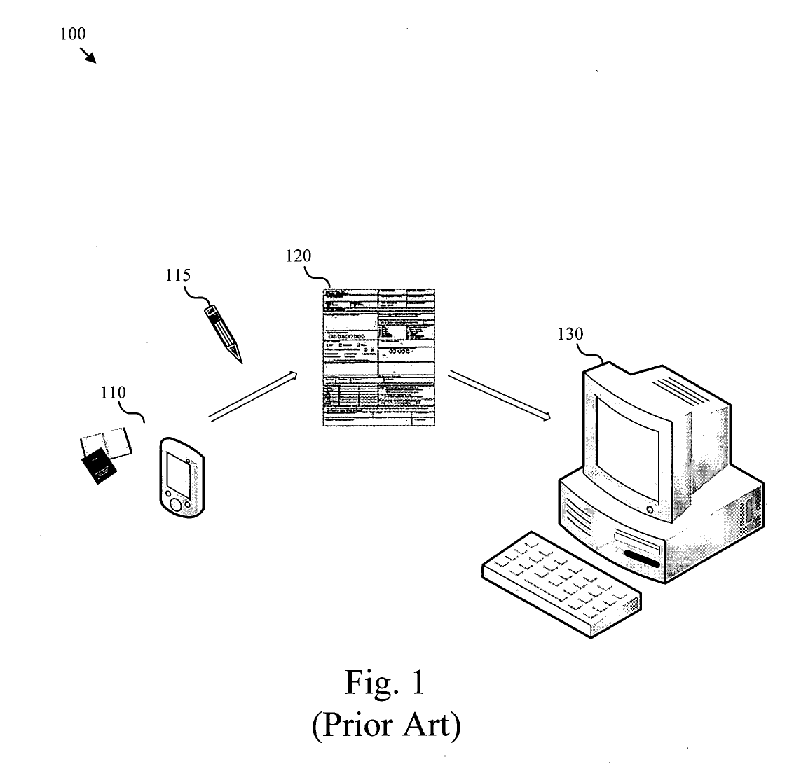

FIG. 2 is a block diagram depicting one embodiment of an electronically accessible personal information system in accordance with the present invention;

FIG. 3 is a block diagram depicting one embodiment of a personal information key in accordance with the present invention;

FIG. 4 is a block diagram depicting one embodiment of a key access module in accordance with the present invention, and

FIG. 5 is a flow chart diagram depicting one embodiment of an information access method in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a signal bearing medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

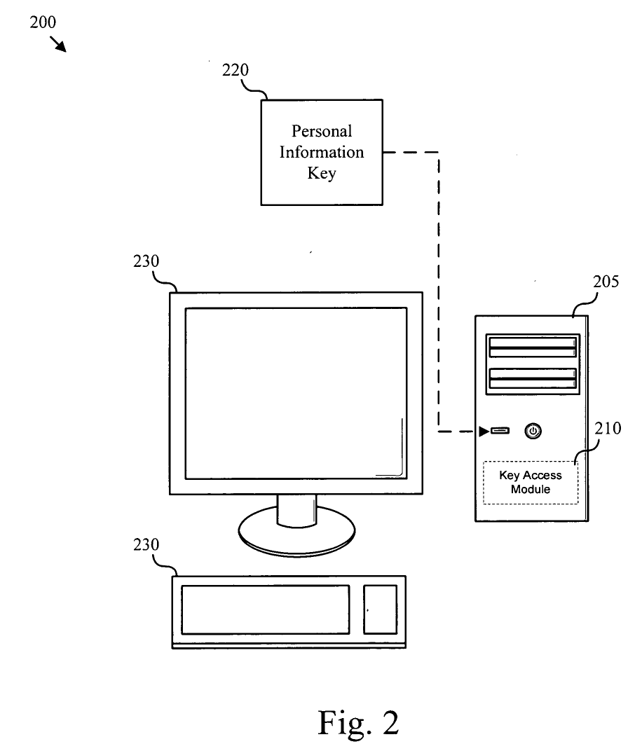

FIG. 2 is a block diagram of one embodiment of an electronically accessible personal information system 200 of the present invention. As depicted, the electronically accessible personal information system 200 includes a computing device 205, a key access module 210, a personal information key 220, and one or more peripheral devices 230. The personal information system 200 facilitates providing personal information into dialogs and forms such as those used in financial and medical transactions. Thus, individuals are able to quickly and easily fill in the dialogs and/or forms they are likely to encounter in various institutions such as banks, medical, and mortgage offices. Additionally, in certain embodiments, individuals are able to carry their complete personal information, including their records and histories, in a device small enough to fit in a pocket or wallet.

As depicted in FIG. 2, the computing device 205 may be any properly configured computing device. For example, the computing device 205 may be a personal computer located in a medical office or a financial institution. In some embodiments, the computing device 205 may be a networked computer or an input terminal. In certain embodiments, the computing device 205 is configured with the necessary application dialogs (such as user dialogs, web pages, and electronic forms) that individuals must fill out to complete their business with the institution.

The computing device illustrated in 205 may contain a key access module 210 configured onto a computer in such a way as to enable the user to plug the personal information key 220 into it. In some embodiments, the key access module 210 manages the transfer of data between the personal information key 220 and any application dialogs, or applications accessing the personal information key 220.

The embodiment of the electronically accessible personal information system 200 depicted in FIG. 2 uses a personal information key 220 that plugs into the key access module 210. In certain embodiments, the key access module 210 may be a port located on the computing device 205. The personal information key 220 may be any device comprising non-volatile memory.

In certain embodiments, the personal information key 220 is preferably packaged in a small form factor. Examples of such devices include, without limitation, cell phones, memory keys, and portable digital assistants. In an additional embodiment, the personal information key 220 might connect by using a wireless technology and, thus, would not need to be directly attached to the computing device 205.

In certain embodiments, the personal information key 220 may store records that contain information such as passwords, addresses, phone numbers, account numbers, and financial and medical records and histories. In addition, the personal information key 220 may contain authentication information useful for authenticating individuals.

As depicted in FIG. 2, the electronically accessible personal information system 200 also includes one or more peripheral devices 230. The peripheral devices 230, such as keyboards, monitors and printers, initiate and enable access between the computing device 205 and the personal information key 220.

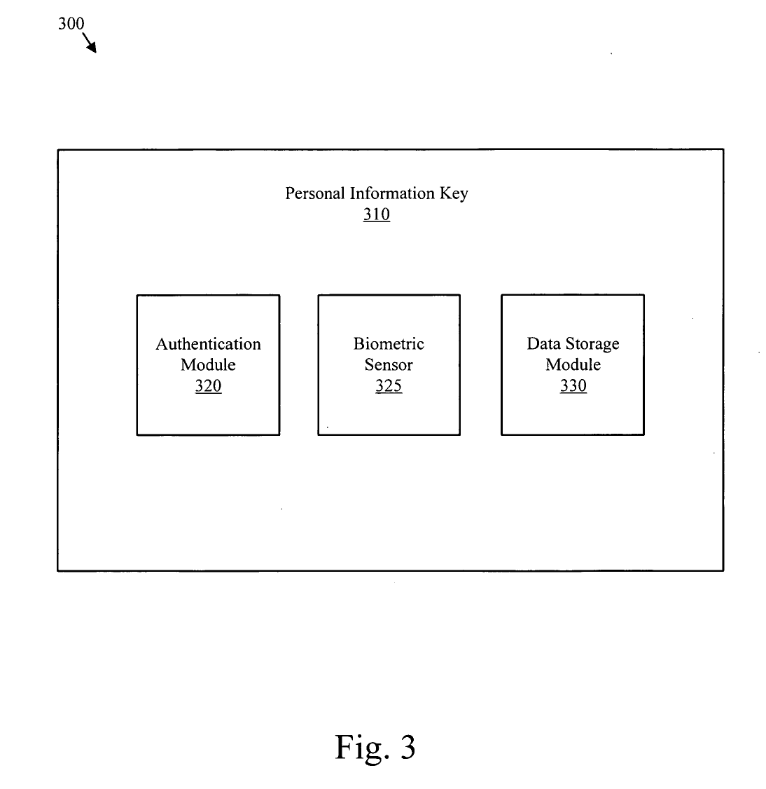

FIG. 3 is a block diagram depicting one embodiment of a personal information key 310 in accordance with the present invention. As depicted, the personal information key 310 includes an authentication module 320, and a data storage module 330. A biometric sensor 325 may optionally be included on the personal information key 310. The personal information key 310 is one example of the personal information key 220 depicted in FIG. 2.

The depicted personal information key 310 contains personal information such as addresses, phone numbers, insurance and account information that individuals repetitively enter on the many application dialogs, web pages, and forms they encounter when they conduct their professional or personal business. Beneficially, the personal information key 310 contains the information necessary to enable individuals to quickly and easily complete the myriad of requests for information they encounter. In addition, the personal information key 310 assists individuals in securely carrying their private, personal information without carrying bulky books and papers. In some embodiments, the personal information key 310 also contains data, such as pertinent medical and financial histories.

The depicted personal information key 310 may include an authentication module 320. In one embodiment, the authentication module 320 ensures that only authorized persons can access the personal information key 310. The authentication module 320 may require a secure login with an authorized password or the like to verify authorized use. In one embodiment, biometric information is verified before the user is authenticated. The biometric information may be provided by the biometric sensor 325 or an external biometric sensor. In some embodiments, the authentication module 320 is used in conjunction with a standard login dialog associated with the operating system of the computing device 205.

In certain embodiments, the authentication module 320 is essentially a dedicated region of memory containing information that enables authentication. This information may be encrypted and match or correlate information provided by other means such as a bar code or biometric sensor. For example, a bar code could be located on the exterior of the personal information key 310 and usage of the personal information key 310 could require the bar code scan to match encrypted information contained in the authentication module 320. Providing both physical and electronic sources of authentication information reduces the likelihood of tampering and information theft.

The data storage module 330 may contain the data individuals must enter on the application dialogs (such as data entry dialogs, web pages, and forms) they encounter. This data may include any data the user wishes to store. In some embodiments, the information on the personal information key 310 includes data such as emergency contact information, personal addresses and phone numbers, blood type, and insurance information. This data could also contain financial accounts and information, as well as data required on any application dialogs individuals must fill out to conduct their professional business.

In certain embodiments, the data on the personal information key 310 is formatted with an industry-standard markup language such as XML. Beneficially, formatting the data with a standard markup language enables applications, and application dialogs, such as web pages and forms, to use this information to auto-fill with the required information. Aside from being easier and faster for the user, auto-filling is more error-proof and helps ensure that the information on the form is accurate. In other embodiments, the data on the personal information key 310 is encrypted and can only be unencrypted when the user supplies the correct credentials. Encrypted information helps prevent information theft and protects the user's privacy.

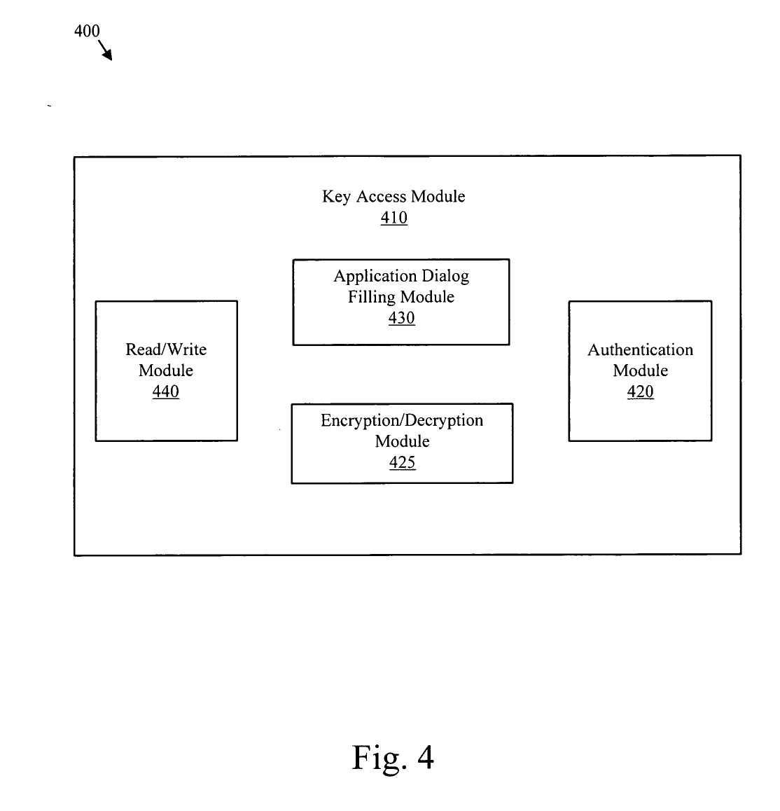

FIG. 4 is a block diagram of one embodiment of a key access module 410 in accordance with the present invention. The key access module 410 may include an authentication module 420, an encryption/decryption module 425, an application dialog filling module 430, and a read/write module 440. The key access module 410 is one example of the key access module 210 depicted in FIG. 2. Beneficially, the key access module 410 enables individuals to access the information in the personal information key 310 to quickly and accurately provide the information necessary to conduct their personal and professional business.

The depicted key access module 410 includes an authentication module 420. The authentication module 420 may interact with the authentication module 320 on the personal information key 310 to ensure that only authorized persons can access the personal information key 310. In certain embodiments, the authentication module 420 may require an authorized password. The authentication module 420 may compare this authentication information with the authentication information stored in the authentication module 320 to verify the authorized user. In some embodiments, the authentication module 420 may include a biometric sensor independent of any biometric sensor on the personal identification key 310.

In one embodiment, biometric information provided by a biometric sensor (accessible to the computing device or the personal key 310) is verified before the user is authenticated. In other embodiments, the authentication module 420 may verify information received from a peripheral such as a barcode scanner with information contained in the personal information key's 310 authentication module 320.

The key access module 410 may also contain an encryption/decryption module 425. If the authentication module 420 authenticates the user, the encryption/decryption module 425 decrypts the information on the personal information key 310 so that the user can read the information. The encryption/decryption module 425 also encrypts the information that is to be written to the key. In some embodiments, the user chooses which information is to be encrypted. Beneficially, the encrypted data keeps the user's personal information private and secure. If the personal information key 310 is lost or stolen, unauthorized individuals will not be able to access the personal data stored on the personal information key 310.

As illustrated in FIG. 4, the key access module 410 may also contain an application dialog filling module 430. In certain embodiments, the data stored in the personal information key 310 may be formatted with an industry standard mark-up language. In some embodiments, the application dialog filling module 430 may use the marked-up data in the personal information key 310 to auto-fill application dialogs and web pages for the user. Beneficially, auto-filling application dialogs not only requires little or no effort from the user, but it is also more error-proof, resulting in an accurate form. In other embodiments, the application dialog filling module 430 presents the data to the user. The user can then select the appropriate information for the form. In certain embodiments, the user can copy and paste the appropriate information into the form.

The key access module 410 may also include a read/write module 440. The read/write module 440 may assist the user in creating and modifying the personal information stored in the personal information key 310. In some embodiments, a user interface, such as a wizard, assists the user in creating the information to write to the personal information key 310. Such an interface might request that the user enter requested information such as addresses, emergency contacts, and medical and financial information such as insurance and financial accounts. The user interface would then format the input information with an industry standard mark-up language, such as XML. In other embodiments, the user would simply fill out a form; the input information would then be saved in an industry standard mark-up language. In additional embodiments, help tools such as wizards and tutorials, may assist the user in formatting information not anticipated by the key access module 410 and write that information to the personal information key 310. The read/write module 440 may also assist the user in reading and modifying any information stored on the personal information key 310.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

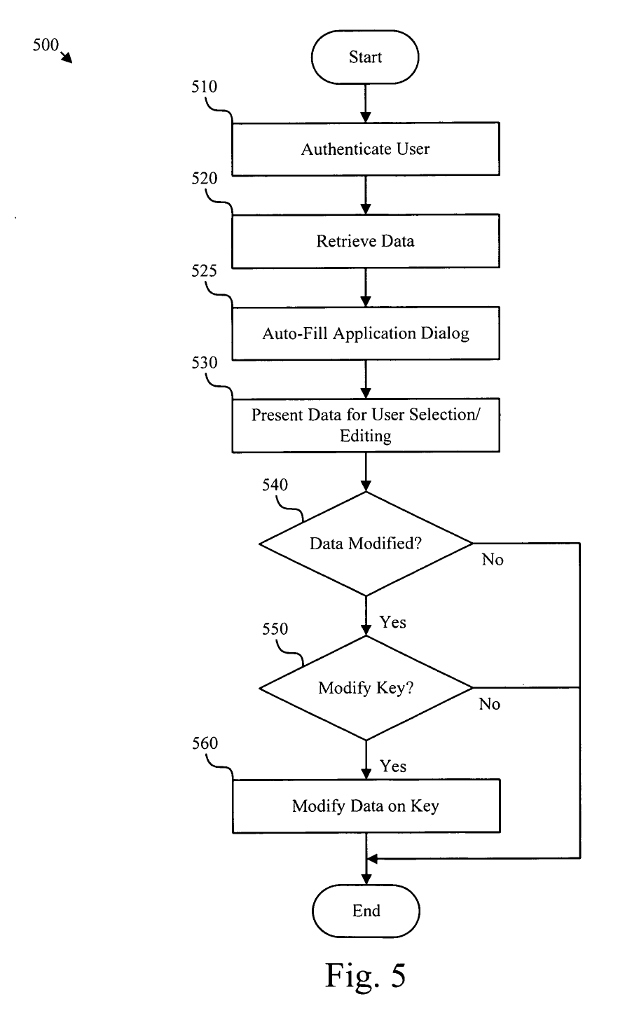

FIG. 5 is a flow chart diagram depicting one embodiment of an information access method 500 in accordance with the present invention. As depicted, the information access method 500 includes an authenticate user operation 510, a retrieve data operation 520, an auto-fill application dialog operation 525, a present data for user selection/editing operation 530, a data modified test 540, a modify key test 550, and a modify data on key operation 560. Beneficially, the electronically accessible personal information method 500 enables individuals to quickly and easily fill out application dialogs without repetitively entering the same information numerous times into numerous dialogs, such as web pages and forms.

In certain embodiments, the authentication modules 320 (FIG. 3) and 420 (FIG. 4) may authenticate 510 a user to ensure that the user has the appropriate password(s) or authentication information to access the information on the personal information key 310. For example, the authentication module 420 may prompt the user for a password or other identifying information and then compare that information with the information stored in the authentication module 320 on the personal information key 310. If the user's authentication information is correct, the information access method 500 continues to the retrieve data operation 520.

As illustrated in FIG. 5, the retrieve data operation 520 may retrieve the data from the personal information key 310 and enable it to be accessed by owner. In some embodiments the retrieve data operation 520 may download the information from the key 310 into a buffer that will temporarily store the data for user selection. In certain embodiments, the retrieve data operation may decrypt the data stored on the personal information key 310. Once the data is retrieved, the information access method 500 may proceed to the auto-fill application dialog operation 525.

The auto-fill application dialog operation 525 may use the data retrieved in the retrieve data operation 520 to auto-fill an electronic form. In some embodiments, the data stored in the personal information key is formatted with an industry standard mark-up language. In these embodiments, the auto-fill application dialog operation 525 may automatically put the information into the appropriate places on the electronic form. In other embodiments, the information stored on the personal information key 310 may be formatted with one of several standard mark-up languages. In these embodiments, the auto-fill application dialog 525 may be configured to recognize the mark-up language and translate the language into a mark-up language the electronic form can use. In additional embodiments, the application dialog filling module 430 cannot auto-fill in the form and may present the data to the user so that the user can select the proper information or copy and paste the information into the form.

Subsequent to filling out the form with the appropriate information, the information access method 500 may continue to the present data for user selection/editing operation 530. In certain embodiments, the electronic form may require information in a slot that the auto-fill application dialog 525 cannot recognize. In other embodiments, the user may want to add additional information to the form. In these embodiments, the present data operation 530 may present the data to the user that the user can select from and add to the form. In additional embodiments, the present data operation 530 may present the data to the user so that the user can modify the personal information stored on the personal information key 310.

As depicted in FIG. 5, the information access method may then proceed to the data modified test 540. Once the form has been filled out, the information access method 500 may test 540 whether the user has modified the personal information. If the personal information has not been modified, the information access method 500 exits. If the personal information has been modified, the information access method 500 may continue to test 550 whether the user desires to save the modified data to the personal information key 310.

The modify data on key test 550 checks whether the user wishes to modify the personal information on the personal information key 310. If the user does not wish to modify the personal information, the information access method 500 exits. However, if the user indicates a desire to modify the data on the personal information key 310, the information access method may continue to the modify data on key operation 560.

The modify data on key operation 560 may write the information changed in the present data for user selection/editing operation 530 to the personal information key 310. In certain embodiments, the modify data on key 560 may assist the user to make other changes to the data or to create new data on the personal information key 310. In some embodiments, the modify data on key operation 560 assists the user in formatting the information with the mark-up language used on the personal information key 310. In certain embodiments, the modify data on key operation 560 may encrypt the data to be written to the personal information key 310. In additional embodiments, the modify data on key operation 560 checks whether the user wishes to encrypt the information. If the user does not wish to encrypt the information, the modify data on key operation 560 may write the data to the key without encrypting it. Once the new information has been written to the personal information key 310, the information access method 500 exits.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system for providing electronically accessible personal information, the system comprising:
a portable memory device comprising non-volatile memory configured to store information, the information comprising personal information specific to at least one individual; and
a computing device comprising a key access module configured to authenticate the user, access the personal information on the portable memory device, and provide the personal information to at least one application running on the computing device.

2. The system of claim 1, wherein the information stored on the non-volatile memory is formatted with a mark-up language.

3. The system of claim 1, wherein the information stored on the non-volatile memory further comprises authentication information.

4. The system of claim 1, where the computing device is further configured to auto-fill an application dialog.

5. The system of claim 1, further comprising a biometric sensor configured to prevent unauthorized access to the personal information.

6. The system of claim 1, wherein the computing device further comprises at least one software application configured to access the information on the portable memory device.

7. An apparatus for providing electronically accessible personal information, the apparatus comprising:
non-volatile memory configured to store information, the information comprising personal information specific to at least one individual;
or the personal information is configured to be formatted with an industry standard mark-up language.

8. The apparatus of claim 7, wherein the information stored on the non-volatile memory further comprises authentication information.

9. The apparatus of claim 7, further comprising a biometric sensor configured to prevent unauthorized access to the personal information.

10. An apparatus for providing electronically accessible personal information, the apparatus comprising:
a key access module configured to access a portable memory device comprising non-volatile memory configured to store information, the information comprising personal information specific to at least one individual;
the key access module further comprising an application dialog filling module configured to auto-fill an application dialog with the personal information.

11. The apparatus of claim 10, wherein the application dialog filling module is further configured to update the information in response to user edits on a form.

12. The apparatus of claim 10, further comprising a read/write module configured to create the information on the non-volatile memory.

13. The apparatus of claim 10, comprising an authentication module configured to authenticate the user.

14. The apparatus of claim 10, further comprising an encryption/decryption module configured to encrypt and decrypt the information stored on the personal information key.

15. A signal bearing medium tangibly embodying a program of machine-readable instructions executable by a digital processing apparatus to perform operations to provide electronically accessible personal information, the operations comprising:
authenticating a user of a portable non-volatile memory device;
auto-filling an application dialog with the information stored on the non-volatile memory, and
presenting the personal information stored on the non-volatile memory device for user selection.

16. The signal bearing medium of claim 15, wherein the operations further comprise modifying the information stored on the non-volatile memory.

17. The signal bearing medium of claim 15, wherein the operations further comprise detecting the presence of a personal information key;

18. The signal bearing medium of claim 15, wherein the operations further comprise translating the information stored on the non-volatile memory into a mark-up language recognizable by the software.

19. The signal bearing medium of claim 15, wherein the operations further comprise presenting the information stored on the non-volatile memory device for user selection.

20. The signal bearing medium of claim 15, wherein the operations further comprise encrypting and decrypting the information stored on the personal information key.
